(19) United States
(12) Patent Application Publication
(10) Pub. No.: US 2007/0129968 A1
(43) Pub. Date: Jun. 7, 2007

(54) System and method for developing a program in a health care facility

(75) Inventors: Jackie Johnson, Wexford, PA (US); Karen Hartman, Pittsburgh, PA (US); David Fuller, Glenshaw, PA (US)

Correspondence Address: FERENCE & ASSOCIATES LLC, 409 BROAD STREET, PITTSBURGH, PA, 15143, US

(73) Assignee: Corazon Consulting, Inc., Pittsburgh, PA (US)

(21) Appl. No.: 11/295,194

(22) Filed: Dec. 5, 2005

(51) Int. Cl. G06Q 99/00; G06Q 10/00

(52) U.S. Cl. 705/2; 705/1

(57) ABSTRACT

A system and method is set forth to utilize the capabilities of a communication through a computer network to make automation of the development of a hospital program feasible. Specifically, the timelines, guidelines, documentation, government standards, and other components of program implementation are set forth in an online application that can be retrieved by clients over a network, such as the Internet, an extranet, an intranet, or any other type of network that is well-known in the art, in an organized, accessible, and user-friendly format.

### FIELD OF THE INVENTION

The present invention relates generally to a program development system for a health care facility, and more particularly to a system and method for developing a specific program for a health care facility through the use of an online application.

### BACKGROUND OF THE INVENTION

The operation and management of a program in a health care facility, such as a hospital, involves much more than simply providing excellent health care to patients. Implementation and operation of a program in a hospital involves the management of clinical, operational, and business concerns. In order to properly run a hospital program, the program must be implemented and developed with these three concerns in mind, allowing for the most efficient and extensive patient care in an environment increasingly aware of governmental and economic issues. Currently, new programs are introduced into hospitals in various ways. The three most utilized methods to develop hospital programs will be detailed below.

One widely used method involves the hospital choosing to implement the program on its own, without any outside help or influence. There are numerous disadvantages with this approach, which include reinventing the wheel, not having the proper and appropriate reference materials on hand, and not have in-house expertise in the development of the program of interest.

Another method in which to develop a hospital program involves the use of a partner hospital. However, similar disadvantages occur with this method. The hospital partner may not use the latest or best practices in their own hospital, transferring the inefficiencies and problems associated with their program to the new hospital program. Further, there often tends to be a lack of focus from the partner, because there are indelibly involved with their own programs and patient care. Another disadvantage with using a hospital partner involves a lack of organization, both with regards to timelines and to having documents readily available and organized.

A third widely used method of implementing a hospital program occurs with the help of consultants that make on-site visits, burdening the hospital with large stacks of paperwork and government standards. These visits are not only costly but time-consuming, and often proceed on the consultant's schedule rather than the hospital's schedule. Further, the programs that are implemented may be standard, without meeting the specific needs or constraints of the hospital. Often, the consultants or hospital partners that guide the development and implementation of a new hospital program only stress one area of development or implementation, such as the issues that arise with the certification and meeting of government standards, or interaction and fusion of the new program with the existing departments in the hospital, including those of staffing, management, and equipment. Further, the time lines by which the development of the program take place are dependent upon outside sources. Thus, the paperwork, documents, standards, and so forth may not always be easily accessibly to a hospital or those managing or requesting the development of a new program at any time which they might wish to access such items. A need is recognized to make the development of a hospital program more efficient, organized, and cost-efficient while allowing for customizability of the program to be well-suited to the hospital

### SUMMARY OF THE INVENTION

The present invention, in accordance with at least one presently preferred embodiment, utilizes the capabilities of a communication through a computer network to make automation of the development of a hospital program feasible. Specifically, the timelines, guidelines, documentation, government standards, and other components of program implementation are set forth in an online application that can be retrieved by clients over a network, such as the Internet, an extranet, an intranet, or any other type of network that is well-known in the art, in an organized, accessible, and user-friendly format.

These timelines, documents, and so forth are available and organized in a user friendly format through a menu on a program home page that allows for an efficient program implementation. Specifically, the menus available for each program include, but are not limited to, Industry Trends, Program Development, Documentation, Operations, Facility Supplies & Equipment, Education, Medical Staff, Quality, Finance, Marketing, Site Visits, and Options. By selecting to view one of these menu items, further information specific to the program and the item is presented. Sub-menus and documents that are available for download are presented to provide a more detailed view of the program and its implementation of each menu item.

In one aspect, the present invention broadly contemplates a system for developing a hospital program, the system comprising means for recognizing an authorized user accessing the system remotely; means for providing the clinical expertise needed to develop a hospital program; means for providing the operational expertise needed to develop a hospital program; and means for providing the business expertise needed to develop a hospital program, wherein the system can be accessed through a network.

In another aspect, the present invention provides a system for facilitating development of a hospital program, the system comprising a memory device for storing information relating to developing a hospital program; a processor in communication with said memory device, said processor being adapted to: output at least one menu to an authorized user located remotely from said memory device; wherein, from said at least one menu, said authorized user may select to view information concerning the development of a hospital program.

In another aspect, the present invention provides a method for facilitating development of a hospital program, the method comprising the steps of authorizing at least one remote recipient to receive information; providing for computer-based viewing of a menu from which a user may select to view information concerning the development of a hospital program; and making available to the authorized recipient information concerning the program development.

In an additional aspect, the present invention provides a program storage device readable by machine for tangibly embodying a program of instructions executable by said machine to perform a method of facilitating the development of a hospital program, said method comprising the steps of authorizing at least one remote recipient to receive information; providing for computer-based viewing of a menu from which a user may select to view information concerning the development of a hospital program; and making available to the authorized recipient information concerning the program development.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is an overall system block diagram of a presently preferred embodiment of the present invention.

FIG. 2 is an overall system block diagram of a central server in accordance with an embodiment of the present invention.

FIG. 3 is an overall block diagram of the method of the present invention in accordance with an embodiment of the present invention.

FIG. 4 is a screenshot of the system after an authorized user has gained access to the system.

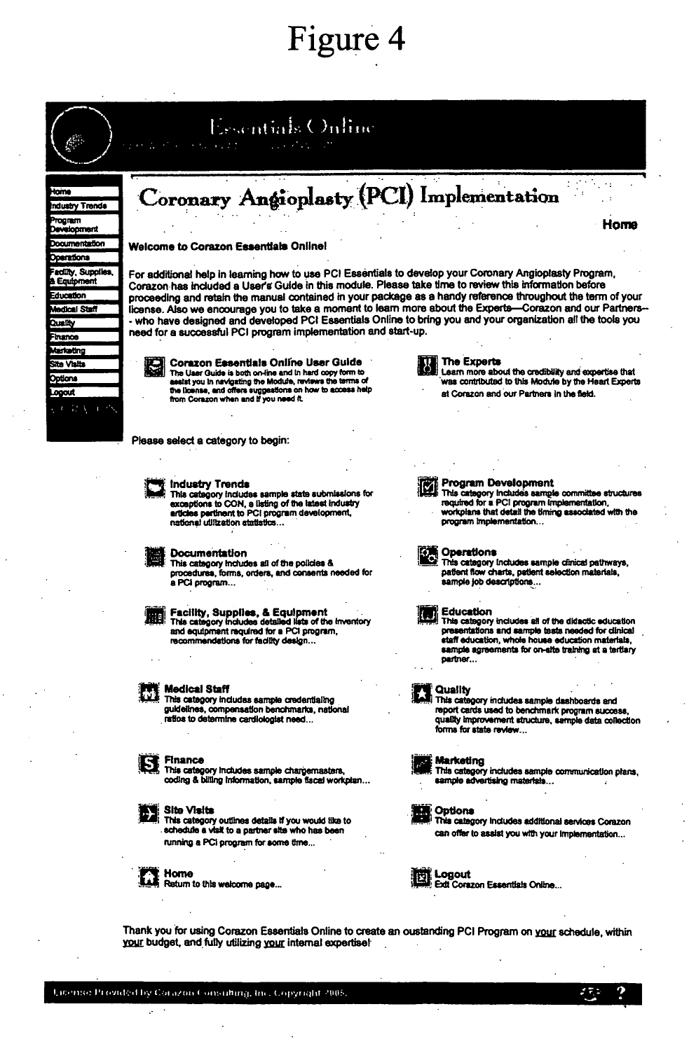

### DETAILED DESCRIPTION OF THE PREFERRED EMBODIMENTS

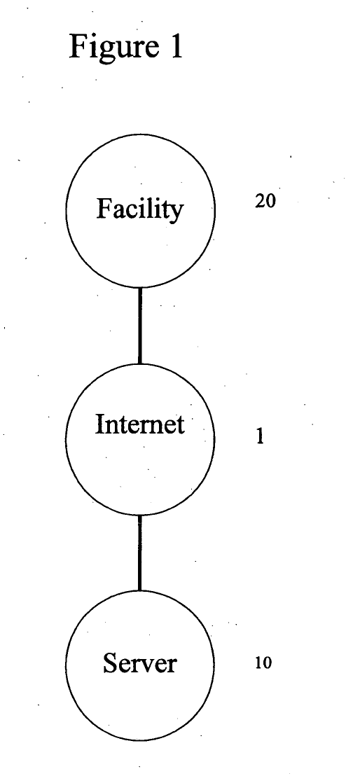

FIG. 1 is an overall system block diagram of a presently preferred embodiment of the present invention. This system enables health care facilities to implement new programs. The system offers a variety of areas and programs to be developed in a health care facility. These areas include, but are not limited to, cardiac, orthopedics, and oncology programs. These programs comprise different modules that can be implemented. For example, the cardiac program includes a Coronary Angioplasty module, vascular module, cardiac cath module, electrophysiology module, women's heart centers, open heart surgery modules, chest pain center modules, and so forth.

In this embodiment, a central server 10 is linked up to at least one remote computer 20 located in a health care facility. Only one remote computer is depicted in FIG. 1, but any number of remote computers may be used. Furthermore, a remote computer may be located in any facility or location, not just in a health care facility, and as discussed below, the remote computers need not be located in the same facility. The link 1 between the central server 10 and the remote computer 20 does not have to be a physical link—it can, for example, be a link via a global computer network as described below, or any other link, including a virtual private network.

The system depicted in FIG. 1 is preferably implemented using existing general purpose computers. Changes to the existing computers to incorporate the present invention may be accomplished in various ways, such as by reprogramming an existing file server or additional file servers. Preferably, the link 1 is a global communications network such as the Internet. Use of a global communications network reduces the cost of implementing the present invention since a private communications network need not be provided, while increasing the geographical range of potential system users. Alternatively, link 1 can be a private communications network, or other appropriate means, such as a direct dial modem connection. The link may also be a secure link, secured for example, through cryptography. The central server 10 is preferably accessed using a standard software browser, such as Netscape Navigator or Microsoft Internet Explorer.

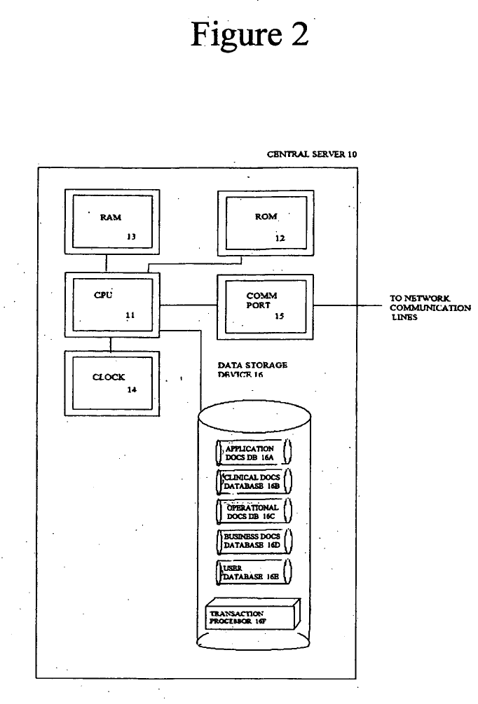

FIG. 2 is a block diagram of a preferred central server 10. The central server includes a CPU 11 which performs the processing functions of the controller. It also includes a read only memory 12 (ROM) and a random access memory 13 (RAM). The ROM 12 is used to store at least some of the program instructions that are to be executed by the CPU 11, such as portions of the operating system or BIOS, and the RAM 13 is used for temporary storage of data. A clock circuit 14 provides a clock signal which is required by the CPU. The use of a CPU in conjunction with ROM, RAM, and a clock circuit is well known to those skilled in the art of CPU based electronic circuit design. The central server 10 also includes a communications port 15 which enables the CPU 11 to communicate with devices external to the central server 10. In particular, the communications port 15 facilitates communication between the network communication lines and the CPU 11, so that information arriving from the network communication lines can be processed by the CPU 11, and the CPU 11 can send information to remote locations. While the illustrated embodiment uses a hard-wired connection to devices outside the central server 10, it should be understood that other methods of communicating with external devices may be used. These other methods include a modem, radio communications, optical communications, and other methods that are well known in the art.

As shown in FIG. 2, the CPU 11 can also store information to, and read information from, data storage device 16. This data storage device 16 includes an application documents database 16a, clinical documents database 16b, operational documents database 16c, business documents database 16d, and user database 16e, which are described below. Additional databases may also be included. In addition, it includes transaction processor instructions 16f, which can be read by and executed by the CPU 11, thereby enabling the CPU 11 to process transactions. While FIG. 2 depicts separate application documents, business documents, clinical documents, operational documents, and user databases, a single database which incorporates all of those functions can also be used.

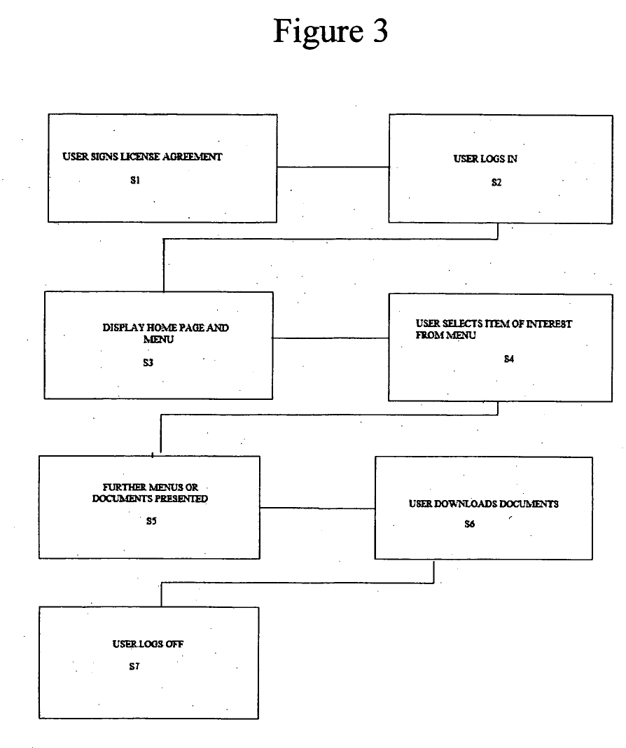

FIG. 3 is a flow chart of the overall process of one embodiment of the present invention. The process starts with the user signing a user license agreement with the proprietors of the system to use the system and application to develop a specific hospital program (Step S1). In a preferred embodiment, the user accesses the application through a browser. The process continues with an authorized user logging into the application via a computer and gaining access to the application pertaining to the specific program that they chose to develop (Step S2). The areas and programs offered by the system are detailed above. Once the user has gained access to the application and the area and program desired, the authorized user is then presented with a home page and a menu from which the user can select one of many areas related to clinical, business and operational guidance for setting up the hospital program (Step S3). The user selects an area of interest and the application then displays information relating to the specific menu item that the user chose to view. (Step S4) This information is displayed as further menus which depict the major sub-areas of the area of interest that the user chose. Upon selecting a further menu, the user is presented with documents or further menus. (Step S5) The information can also be displayed as links to documents, or as a combination of menus and documents. Upon clicking on a link to a document, the user chooses to download the document. (Step S6) These documents are of various formats (.doc, .pdf, .html, and other formats that are well-known in the art) that the user can download and view at their leisure. From the menu, the user can also select to view or download an online user guide or view information regarding the experts involved with the system that contribute to and help with the development of the model program for the hospital. (Step S4) Once the user is done navigating the system, the user can logout of the system, or close the application by any other means well-known in the art (closing the application browser, etc.). (Step S7)

The user guide is an online copy of a user guide that the user receives in hard copy when the user signs the user license. The guide assists the user in navigating the application, reviews the terms of the license, and offers suggestions on how to access help from the system proprietors when and if such help is needed. The information about the experts include biographies through which the user can learn more about the credibility and expertise that was contributed to the system by the heart experts and their partners in the field that are chosen to work with the system. Further, the information about the Experts includes information about the expert that was chosen by the system and/or its proprietors to work with the authorized user. This expert has the ability to assist the user with any problems or needs the authorized user may have concerning the system or the application. Further, the expert will facilitate any further communications (site visits, conference calls, etc.). In addition to the expert assigned to the user, the user also has access to a system help desk to assist the user in using and navigating through the application and working with the files and documents the user may choose to download.

The user guide and expert information assist the user in maximizing their experience with the system. The other menu items are areas of interest which are useful in the development of the program that the user desires to implement. The main areas of interest that can be chosen by a user to view come under the branches of clinical, operational, and business guidance for development of a hospital program. Further, guidelines are available as to the development of the program, including but not limited to timelines, expert contacts, government standards, and so forth. However, for clarity and ease of understanding, these three main areas are not set forth as menu items once the authorized user is presented with the home page. Rather, these three main areas have been delineated into several categories of information which appear as menu items from which the user can select to see more information.

These categories include, but are not necessarily limited to: Industry Trends, Program Development, Documentation, Operations, Facility Supplies & Equipment, Education, Medical Staff, Quality, Finance, Marketing, Site Visits, and Options.

Upon selecting to view information from any of the above categories, the user is presented with a page from which documents or further menus of sub-areas may be chosen to view. Additionally, the user can choose to view Links, Options, or Logout. By selecting to view Links, the user is presented with links thought useful to the user. These links may include, but are not limited to, links to portions of materials of interest within the system, other websites operated by the proprietors of the system, research studies pertaining to the hospital program being developed, or success stories regarding other users who have used the system. By choosing Options, the user is presented with options that allow the user to customize how they use the system. By choosing Logout, the user logs out of the system and is presented with the login page again.

Upon selecting to view information regarding Industry Trends, the user is presented with documents for download which may include, but are not limited to, the latest journal articles in the field, statistics pertaining to the field and the utilization of such programs on local and national levels, and so forth. These documents may be compiled in a further organized manner, such that the user is presented with another menu upon selecting to view Industry Trends. For example, in setting up a Coronary Angioplasty program, this category may possibly include, but not limit itself to, documents pertaining to national statistics and journal articles, and further menus which may include, but are not limited to, statewide activity, trends, and literature reviews. By clicking on one of these further menus, the user is then presented with pertinent documents or further submenus that contain organized sub-areas of material.

Upon selecting to view information regarding Program Development, the user is presented with documents for download which help structure the implementation process to achieve an on-time and on-budget outcome with all the essential areas addressed. This category provides the user with the planning forums and meeting formats that will assure that the users are including the key stakeholders and sequencing action steps in an appropriate fashion. Upon selecting to view information regarding Documentation, the user is presented with documents for download and further menus which may include, but are not limited to, policies & procedures, forms, orders, consents needed for the selected program, and so forth. For example, in setting up a Coronary Angioplasty program, this category may possibly include, but not limit itself to, documents pertaining to committee structure, and menus that allow the user to click on and view meeting agendas, workplans, and timelines.

Upon selecting to view information regarding Operations, the user is presented with documents for download and further menus which may include, but are not limited to sample clinical pathways, patient flow charts, patient selection materials, sample job descriptions, and so forth. For example, in setting up a Coronary Angioplasty program, this category may possibly include, but not limit itself to, documents and menus pertaining to guidelines & agreements, patient selection, sample job descriptions, sample patient flows, start-up checklists, and so forth.

Upon selecting to view information regarding Facilities, Supplies & Equipment, the user is presented with documents for download and further menus which may include, but are not limited to detailed lists of the inventory and equipment required for a hospital program, recommendations for facility design, and so forth. For example, in setting up a Coronary Angioplasty program, this category may possibly include, but not limit itself to, documents and menus pertaining to facilities, supplies, equipment, and so forth.

Upon selecting to view information regarding Education, the user is presented with documents for download and further menus which may include, but are not limited to didactic education presentations and sample tests needed for clinical staff education, whole house education materials, sample agreements for on-site training, and so forth. For example, in setting up a Coronary Angioplasty program, this category may possibly include, but not limit itself to, documents and menus pertaining to patient & family, and staff, as well as competency checklists and post-exams and so forth.

Upon selecting to view information regarding Medical Staff, the user is presented with documents for download and further menus which may include, but are not limited to sample credentialing guidelines, compensation benchmarks, national ratios to determine staff needs, and so forth. For example, in setting up a Coronary Angioplasty program, this category may possibly include, but not limit itself to, documents and menus pertaining to credentialing guidelines, risk stratification criteria, medical coverage models, and so forth.

Upon selecting to view information regarding Quality, the user is presented with documents for download and further menus which may include, but are not limited to dashboards and report cards used to benchmark program success, quality improvement structure, sample data collection forms for state review, and so forth. For example, in setting up a Coronary Angioplasty program, this category may possibly include, but not limit itself to, documents and menus pertaining to quality improvement structure, sample dashboards, quality review forums, data collection metrics and benchmarks, and so forth.

Upon selecting to view information regarding Finance, the user is presented with documents for download and further menus which may include, but are not limited to dashboards and report cards used to benchmark program success, quality improvement structure, sample data collection forms for state review, and so forth. For example, in setting up a Coronary Angioplasty program, this category may possibly include, but not limit itself to, documents and menus pertaining to charge description master, coding & reimbursement, sample budgets, charge guidelines, and coding information, and so forth.

Upon selecting to view information regarding Marketing, the user is presented with documents for download and further menus which may include, but are not limited to sample communication plans, sample advertising materials, and so forth. For example, in setting up a Coronary Angioplasty program, this category may possibly include, but not limit itself to, documents and menus pertaining to budget, sample materials, workplans & campaigns, and so forth.

Upon selecting to view information regarding Site Visits, the user is presented with documents for download and further menus which may include, but are not limited to details if you would like to schedule a visit to a partner site who has been running the hospital program for some time, and so forth. For example, in setting up a Coronary Angioplasty program, this category may possibly include, but not limit itself to, cost and terms, and how to schedule a site visit.

Upon selecting to view information regarding Options, the user is presented with documents for download and further menus which may include, but are not limited to additional services the system and its proprietors can offer to assist you with your implementation. For example, in setting up a Coronary Angioplasty program, this category may possibly include, but not limit itself to, best clinical practice, board of director retreats, expansion plans, certification preparation, contract negotiations, feasibility studies, financial analysis & pro formas, hospital design, joint ventures, market analysis, and so forth.

Other services that may assist with implementation may have to do with the set up of the application itself. For example, documents that are currently downloaded may be maintained on a server that is local to the client. Various other changes to the application can be made available under these menu items as it is made apparent that such changes will better serve clients using the application.

The documents made available for download upon perusal of these categories are stored in the corresponding databases, including the application documents database 16a, clinical documents database 16b, business documents database 16c, and operational documents database 16d. The databases may be further fragmented in tables that pertain to the categories of the specific program, and may include such information as number of times a document is accessed, who accesses the documents, and so forth.

The user database 16e contains documents and entries including, but not limited to, those pertaining to the users licensed to use the system and the specific programs that they desire to develop and implement. The user database 16e preferably contains information on the registered users of the present invention. Such information may include identifying information, along with historical information on the user's use of the present invention.

By allowing the user to select the areas in which the user has interest and by providing a large variety of information and documents for the user's perusal, the system allows for customization of the program being developed. Further, the system still accommodates site visits and conference calls for one-on-one communication with the experts of the system and the system proprietors to help users customize and develop their programs to best suit the hospitals or facilities into which the programs will be integrated.

In recapitulation, the present invention, in accordance with at least one presently preferred embodiment, provides a system and method for developing a hospital program. As such, it is to be understood that the present invention, in accordance with at least one presently preferred embodiment, may be utilized in environments other than hospitals, such as long term care facilities, hospices, or any other environment in which there is a patient care.

It is to be understood that the present invention, in accordance with at least one presently preferred embodiment, includes authorizing at least one remote recipient to receive information, providing for computer-based viewing of a menu from which a user may select to view information concerning the development of a hospital program, and making available to the authorized recipient information concerning the program development. Together, these may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for developing a program in a health care facility, said system comprising:
a recognizer which recognizes at least one authorized user accessing the system remotely;
a clinical provider which provides the clinical expertise needed to develop a program at a health care facility;
an operational provider which provides the operational expertise needed to develop a program at a health care facility; and
a business provider which provides the business expertise needed to develop a program at a health care facility,
wherein the system can be accessed through a network.

2. The system of claim 1, further comprising:
a program customizer which customizes the health care facility program.

3. The system of claim 1, wherein the clinical provider includes at least one database which contains a plurality of documents.

4. The system of claim 1, wherein the operational provider includes at least one database which contains a plurality of documents.

5. The system of claim 1, wherein the business provider includes at least one database which contains a plurality of documents.

6. The system of claim 1, wherein the at least one authorized user has signed a license agreement with at least one proprietor of the system.

7. The system of claim 1, further comprising:
a visit scheduler for at least one expert to conduct at least one site visit to the health care facility.

8. The system of claim 8, further comprising:
a call scheduler for the at least one expert and the at least one authorized user to conduct at least one conference call.

9. A system for developing a program in a health care facility, said system comprising:
a memory device for storing information relating to developing a hospital program;
a processor in communication with said memory device, said processor being adapted to:
output at least one menu to at least one authorized user located remotely from said memory device;
wherein, from said at least one menu, said at least one authorized user may select to view information concerning the development of a program at a health care facility.

10. The system of claim 9, wherein the information includes information pertaining to the clinical, business, and operational expertise needed to develop a program at a health care facility.

11. The system of claim 10, wherein the information can be used to customize the health care facility program.

12. The system of claim 10, wherein the information is provided from at least one database which contains a plurality of documents.

13. The system of claim 10, wherein the at least one authorized user has signed a license agreement with at least one proprietor of the system.

14. The system of claim 10, wherein the at least one expert conducts at least one site visit to the health care facility.

15. A method for facilitating development of a program in a health care facility, the method comprising the steps of:
authorizing at least one remote recipient to receive information;
providing for computer-based viewing of a menu from which a user may select to view information concerning the development of a program in a health care facility; and
making available to the authorized recipient information concerning the program development.

16. The system of claim 15, wherein the information includes information pertaining to the clinical, business, and operational expertise needed to develop a program at a health care facility.

17. The system of claim 16, wherein the information can be used to customize the health care facility program.

18. The system of claim 16, wherein the information is provided from at least one database which contains a plurality of documents.

19. The system of claim 16, wherein the at least one authorized user has signed a license agreement with at least one proprietor of the system.

20. The system of claim 16, wherein the at least one expert conducts at least one site visit to the health care facility.

21. A program storage device readable by machine for tangibly embodying a program of instructions executable by said machine to perform a method of facilitating the development of a program in a health care facility, said method comprising the steps of:
authorizing at least one remote recipient to receive information; providing for computer-based viewing of a menu from which a user may select to view information concerning the development of a program in a health care facility; and
making available to the authorized recipient information concerning the program development.
